(19) United States
(12) Patent Application Publication
(10) Pub. No.: US 2022/0328936 A1
(43) Pub. Date: Oct. 13, 2022

(54) ELECTRICAL TOOL AND ENERGY STORAGE APPARATUS THEREOF

(71) Applicant: Positec Power Tools (Suzhou) Co., Ltd., Suzhou (CN)

(72) Inventors: Yu ZHANG, Suzhou (CN); Shiping JIAO, Suzhou (CN)

(21) Appl. No.: 17/833,853

(22) Filed: Jun. 6, 2022

Related U.S. Application Data
(63) Continuation of application No. PCT/CN2020/133500, filed on Dec. 3, 2020.

(30) Foreign Application Priority Data
Dec. 6, 2019 (CN) 201922169602.0

(51) Int. Cl. H01M 50/51; H01M 50/213; H01M 50/247; H01M 50/271; H01M 50/543

(52) U.S. Cl. CPC H01M 50/51; H01M 50/213; H01M 50/247; H01M 50/271; H01M 50/543; A01D 34/78

(57) ABSTRACT

The present utility model relates to an electrical tool and an energy storage apparatus, including a shell, a first mating port configured to detachably mate with a second mating port on the electrical tool, a positive terminal and a negative terminal, where the energy storage apparatus further includes a battery unit, the battery unit is accommodated in the shell, the battery unit is formed by a plurality of cells connected in series, an allowable output power of the energy storage apparatus is higher than 1200 W, and an output voltage of the plurality of cells connected in series is not higher than 60 V. Therefore, a higher output power is provided to meet power requirements of a high-power tool, and a requirement for the electrical tool is low, which reduces costs.

### CROSS-REFERENCE TO RELATED APPLICATIONS

This application is a Continuation of International Application No. PCT/CN2020/133500, filed on Dec. 3, 2020, which claims the benefit of and priority to Chinese Patent Application No. 201922169602.0, filed on Dec. 6, 2019, all content thereof is incorporated herein by reference in their entireties.

### BACKGROUND

### Technical Field

The present utility model relates to the field of electrical tools, and specifically, to an energy storage apparatus with high energy density and an electrical tool equipped with same.

### Related Art

As the application range of power tools expands, the power tools are widely applied to home improvement as well as outdoor and DIY projects. The power tools include at least the following two categories according to energy types of the power tools: a fuel tool powered by fuel (such as gasoline) and a direct current (DC) electrical tool powered by a DC power supply. In the low-power area, DC electrical tools can basically replace fuel tools. However, in the high-power area, such as higher than 1200 W, it is difficult for DC electrical tools to replace fuel tools. The reason is that a high-power tool requires a DC power supply that can provide sufficient power output, but as the most conventional form of the DC power supply, a battery pack usually can only provide power ranging from 400 W to 1100 W, which cannot meet the power requirement of the high-power tool. However, a high-power fuel tool also has obvious disadvantages, such as loud noise during operation, serious pollution to the environment caused by exhaust gas generated by the high-power fuel tool, and a heavy whole machine.

In one of the existing solutions, to make the electrical tool output a high power, a plurality of cells connected in series are used, to make an output voltage of the battery pack higher. Limited by the discharge capacity (20 A) and the capacity limit (3 Ah) of the battery pack, the output voltage of the battery pack in series connection is higher than 60 V, which exceeds a safe voltage, and causes danger to operators.

In another existing solution, to make the electrical tool output a high power, cells or battery packs are connected in parallel. However, a parallel connection causes the cells or battery packs to charge each other. When the cells have different voltages, there is a risk that a high-voltage cell charges a low-voltage cell, which is referred to as a mutual charging risk for short. In a process of mutual charging, the greater the voltage difference, the higher the charging current. A high current causes serious damage to a charged cell and a discharged cell, and even causes danger.

Therefore, it is very necessary to provide a power tool that is environmentally friendly and that has a high power.

### SUMMARY

To overcome defects of the related art, the problem to be resolved by the present utility model is to provide a novel energy storage apparatus with a large capacity to resolve the existing technical problems and broaden an application range of the energy storage apparatus.

The technical solutions adopted in the present utility model for resolving the existing technical problems are as follows:

An energy storage apparatus is provided, including a shell, a first mating port configured to detachably mate with a second mating port on an electrical tool, a positive terminal, and a negative terminal, where the energy storage apparatus further includes a battery unit, the battery unit is accommodated in the shell, the battery unit includes a plurality of cells, the plurality of cells are connected in series to each other, an allowable output power of the energy storage apparatus is higher than 1200 W, and a voltage of the plurality of cells connected in series is not higher than 60 V.

Preferably, the voltage of the plurality of cells connected in series ranges from 40 V to 60 V, an output power of the energy storage apparatus ranges from 1200 W to 1800 W, and a power-to-volume ratio of the energy storage apparatus ranges from 3.8 W/cm³ to 4.0 W/cm³.

Preferably, the battery unit includes at least 10 cells, the output power of the energy storage apparatus ranges from 1200 W to 1400 W, and a volume of the battery unit is greater than 300 cm³.

Preferably, a number of the cells is 10, allowable discharge currents of the cells are not lower than 30 A, the cells are arranged in an upper layer and a lower layer, 5 cells arranged side by side are arranged in each of the upper layer and the lower layer, and a central axis of a cell in the upper layer is aligned with a central axis of a corresponding cell in the lower layer.

Preferably, the battery unit includes at least 12 cells, the output power of the energy storage apparatus ranges from 1400 W to 1600 W, and a volume of the battery unit is greater than 370 cm³.

Preferably, a number of the cells is 12, allowable discharge currents of the cells are not lower than 30 A, the cells are arranged in an upper layer, a middle layer, and a lower layer, 4 cells arranged side by side are arranged in each of the upper layer, the middle layer, and the lower layer, and central axes of corresponding cells in the upper layer, the middle layer, and the lower layer are aligned with each other.

Preferably, the battery unit includes at least 14 cells, the output power of the energy storage apparatus ranges from 1600 W to 1800 W, and a volume of the battery unit is greater than 430 cm³.

Preferably, a number of the cells is 14, allowable discharge currents of the cells are not lower than 30 A, the cells are arranged in an upper layer and a lower layer, 7 cells arranged side by side are arranged in each of the upper layer and the lower layer, and a central axis of a cell in the upper layer is aligned with a central axis of a corresponding cell in the lower layer.

An electrical tool, including an electrical tool body and an energy storage apparatus configured to power the electrical tool body, where the electrical tool body includes: a motor, configured to obtain electrical energy from the energy storage apparatus to output rotational motion; a second mating port, configured to mate with the energy storage apparatus to obtain the electrical energy; and the energy storage apparatus is the energy storage apparatus according to the foregoing embodiments.

Preferably, the electrical tool is an outdoor electrical tool.

Compared with the related art, the beneficial effects of the present utility model are as follows: according to the present utility model, the allowable output power of the energy storage apparatus is higher than 1200 W, the cells are connected in series, and the voltage of a plurality of battery cells connected in series is not higher than 60 V, which can provide a large output power to meet the power requirements of the high-power tools, avoid a risk that a high-voltage cell charges a low-voltage cell due to parallel connection between the battery units, and have low requirements for the electrical tools to reduce costs.

### BRIEF DESCRIPTION OF THE DRAWINGS

The foregoing objects, technical solutions, and beneficial effects of the present utility model can be implemented with reference to the accompanying drawings below:

FIG. 1 is a schematic three-dimensional diagram of an electrical tool according to a first preferred embodiment of the present utility model.

FIG. 2 is a schematic structural diagram of an energy storage apparatus of the electrical tool shown in FIG. 1.

FIG. 3A and FIG. 3B are schematic diagrams of an arrangement of cells in an energy storage apparatus formed of 18650 cells connected in parallel.

FIG. 4A and FIG. 4B are schematic diagrams of an arrangement of cells in an energy storage apparatus formed of 21700 cells connected in series.

### DETAILED DESCRIPTION

To make the foregoing objectives, features and advantages of the present utility model more comprehensible, specific implementations of the present utility model are described below in detail with reference to the accompanying drawings. In the following description, many details are described to help fully understand the present utility model. However, the present utility model can be implemented in many other ways different from those described herein, and a person skilled in the art can make similar improvements without departing from the concept of the present utility model. Therefore, the present utility model is not limited by the specific embodiments disclosed below.

It should be noted that, when an element is considered to be “connected” to another element, the element may be directly connected to the another element, or an intermediate element may exist at the same time, or the element may be electrically connected to the another element.

Unless otherwise defined, meanings of all technical and scientific terms used in this specification are the same as those usually understood by a person skilled in the art to which the present utility model belongs. In this specification, terms used in the specification of the present utility model are merely intended to describe objectives of the specific embodiments, but are not intended to limit the present utility model. The term “and/or” used in this specification includes any and all combinations of one or more related listed items. The electrical tool mentioned in the present utility model can be a lawn mower or a sweeper. The electrical tool includes one energy storage apparatus, two energy storage apparatuses, or a plurality of energy storage apparatuses (a number of the energy storage apparatuses depends on an application scenario and a tool type).

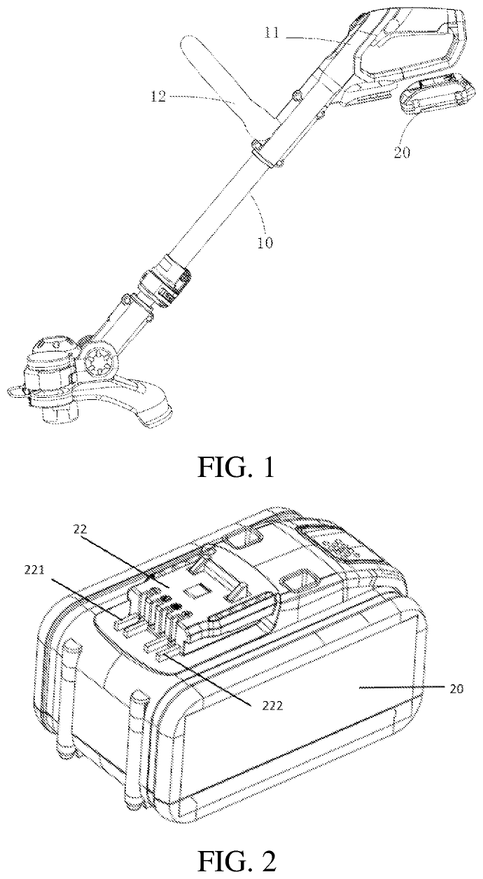

FIG. 1 is a schematic three-dimensional diagram of an electrical tool according to a first preferred embodiment of the present utility model. The electrical tool includes an electrical tool body 10 and an energy storage apparatus 20. The energy storage apparatus 20 is detachably mounted to the electrical tool body 10, to provide energy for the electrical tool body 10. In an embodiment, the electrical tool body 10 further includes an auxiliary handle 12. Referring to FIG. 2, the energy storage apparatus 20 includes a first shell 21, a battery unit accommodated in the first shell 21, a first mating port 22 arranged on the first shell 21, and a positive terminal 221 and an negative terminal 222 arranged in the first mating port 22, where the positive terminal 221 and the negative terminal 222 are respectively connected to a positive terminal and a negative terminal of the electrical tool, to output electrical energy. The energy storage apparatus 20 includes a plurality of cells electrically connected to each other. The electrical tool body 10 includes a second shell 11, a motor accommodated in the second shell, and a second mating port detachably mating with the first mating port 22 of the energy storage apparatus 20. A third pole piece and a fourth pole piece are arranged in the second mating port, and are respectively electrically connected to the positive terminal 221 and the negative terminal 222 of the energy storage apparatus 20, to obtain electrical energy from the energy storage apparatus 20 and provide energy for the motor to rotate. A locking structure is also arranged on the energy storage apparatus 20. After being correctly mounted to the electrical tool 10 by using a slide rail, the energy storage apparatus 20 is locked by the locking structure to be avoided from being disengaged. When the energy storage apparatus 20 needs to be removed, the locking structure needs to be triggered to enter an unlocked state, and then the energy storage apparatus 20 is pulled out.

FIG. 2 is a schematic structural diagram of an energy storage apparatus according to a first preferred embodiment of an electrical tool. The energy storage apparatus 20 includes a plurality of cells 200. The plurality of cells 200 are lithium ion cells 200. The plurality of cells 200 are connected in series to form the energy storage apparatus 20. A circuit board, an electrode plate arranged on the circuit board and configured to electrically connect to the cells 200, and a connection plate configured to connect two adjacent cells 200 in series are arranged in the energy storage apparatus 20. The output power of the energy storage apparatus 20 depends on a product of an output voltage of the cells 200 connected in series and an allowable average discharge current. The output voltage depends on a rated voltage of a single cell 200 and a number of the cells 200 connected in series, and an allowable average discharge current depends on an allowable average discharge current of a single cell 200 and a number of the cells 200 connected in parallel.

In a possible scenario, a rated power of the electrical tool 10 is 1200 W. The rated power means a rated input power. To meet the rated power, an output power of the energy storage apparatus 20 needs to reach 1200 W. In the related art, an energy storage apparatus 20 including 18650 cells 200 is configured to provide electrical energy for a tool.

If the existing energy storage apparatus 20 is adopted, cells of the existing energy storage apparatus 20 are 18650 cells 200. To reach a rated output power of 1200 W, the energy storage apparatus 20 includes a battery unit formed by 15 18650 cells 200 that are connected in series to each other, and the energy storage apparatus 20 includes a battery unit 200, that is, the energy storage apparatus includes 15 18650 cells 200 connected in series to each other. The energy storage apparatus 20 is respectively connected to a positive electrode and a negative electrode of the electrical tool by the positive terminal 221 and the negative terminal 222, to provide electrical energy for the electrical tool. The 18650 cell 200 has an average discharge current of 20 A, a full charge voltage of 4.0 V/Cell, a weight of 45 g/Cell, a diameter of 18 mm, and a height of 65 mm. An output voltage of 15 18650 cells connected in series is 15*4 V/Cell=60 V. The energy storage apparatus 20 has an output voltage of 60 V, an output power of 60 V*20 A=1200 W, and a weight of 15*45 g/Cell=675 g. A power-to-weight ratio of the energy storage apparatus 20 is 1200 W/675 g=1.778 W/g. The 15 cells 200 in the energy storage apparatus are divided into three groups, each group includes 5 cells 200, and the three groups of cells 200 are arranged in an upper layer, a middle layer, and a lower layer. Based on such arrangement, the energy storage apparatus 20 has a length of 18*5=90 mm, a width of 65 mm, a height of 18*3=54 mm, and a volume of 90*65*54=315.9 cm³. A power-to-volume ratio of the energy storage apparatus 20 is 1200 W/315.9 cm³=3.799 W/cm³.

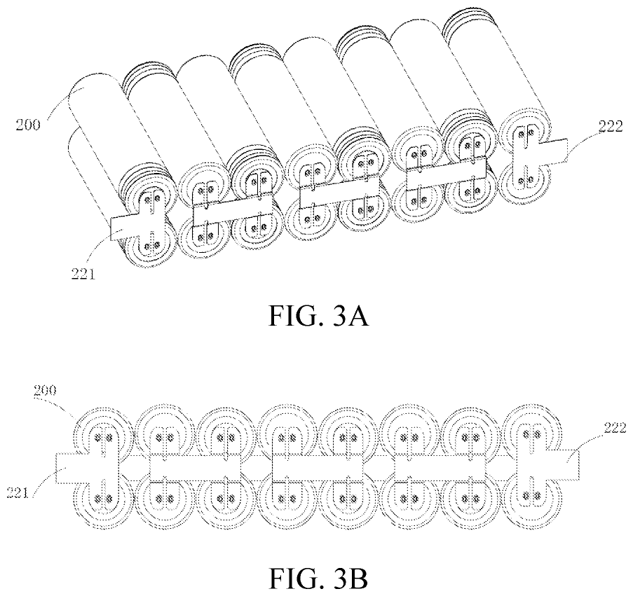

In the foregoing embodiment, the energy storage apparatus 20 includes 15 18650 cells 200 connected in series, and the output voltage of the energy storage apparatus reaches 60 V, which exceeds a safe voltage and poses a safety risk. In addition, after mating with a tool, the energy storage apparatus 20 has higher galvanic isolation requirements for the electrical tool and higher design requirements for the tool. To reduce the safety risk, design difficulty, and costs, in the related art, an energy storage apparatus is further provided. The energy storage apparatus includes 16 cells. The 16 cells form two battery units. The two battery units are connected in parallel. Each battery unit includes 8 cells. The 8 cells are connected in series to each other. Referring to FIG. 3A and FIG. 3B, the energy storage apparatus 20 includes 16 cells 200. Two upper and lower cells 200 are connected in parallel to form a battery pack. The 16 cells 200 form 8 battery packs. The 8 battery packs are connected in series to form the energy storage apparatus 20. The energy storage apparatus 20 further includes a positive terminal 221 and a negative terminal 222 that are respectively electrically connected to a third pole piece and a fourth pole piece in the electrical tool body 10, to provide electrical energy for the electrical tool body. According to the specifications of the 18650 cell, each battery unit has an output voltage of 8*4 V/Cell=32 V and an allowable average discharge current of 20 A. Two battery units connected in parallel still have an output voltage of 32 V and have an allowable average discharge current of 2*20 A=40 A. In this embodiment, the energy storage apparatus 20 has an output voltage of 32 V, an output power of 32 V*40 A=1280 W, and a weight of 16*45 g/Cell=720 g. A power-to-weight ratio of the energy storage apparatus is 1280 W/720 g=1.778 W/g. The two battery units in the energy storage apparatus 20 are arranged in an upper layer and a lower layer, and 8 cells 200 are arranged in each layer. Based on such arrangement, the energy storage apparatus 20 has a length of 18*8=144 mm, a width of 65 mm, a height of 18*2=36 mm, and a volume of 144*65*36=336.96 cm³. A power-to-volume ratio of the energy storage apparatus 20 is 1280 W/336.96 cm³=3.799 W/cm³.

In the foregoing embodiment, the energy storage apparatus 20 includes 16 18650 cells 200, and there is a parallel connection between the cells 200. An output voltage of the cells 200 after the parallel connection is 32 V, which is less than 60 V and meets requirements for the safety of operators, and there is no need to arrange galvanic isolation for the electrical tool. However, because the two battery units are connected in parallel, when the two battery units have different voltages, there is a risk that a battery unit with a higher voltage charges a battery unit with a lower voltage, which is referred to as a mutual charging risk for short. In a process of mutual charging, the greater the voltage difference, the higher the charging current. A high current causes serious damage to both a charged battery unit and a discharged battery unit, and even causes danger.

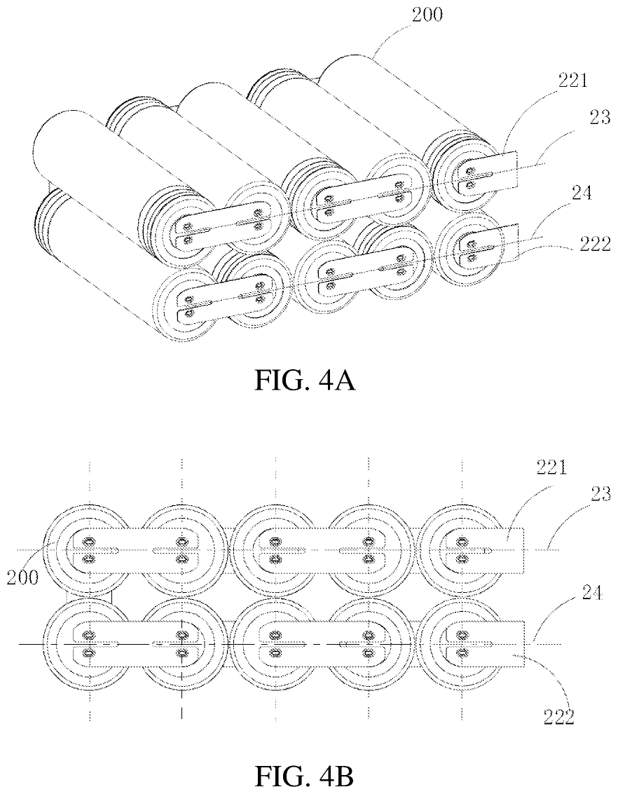

To resolve the operator safety problem, the damage to the battery pack, and the costs problem that the energy storage apparatus including 18650 cells in the related art faces when the energy storage apparatus needs to be output a power of 1200 W, the present utility model provides an energy storage apparatus, including a battery unit, where the battery unit includes a plurality of 21700 cells, and the plurality of cells are connected in series. In a second preferred embodiment of the present utility model, referring to FIG. 4A, the battery unit includes 10 cells 200, and the 10 cells 200 are connected in series. The battery unit further includes a circuit board, an electrode plate arranged on the circuit board and configured to electrically connect to the cells 200, and a connection plate configured to connect two adjacent cells 200 in series. The 21700 cell 200 has an average discharge current of 30 A, a full charge voltage of 4.0 V/Cell, a weight of 70 g/Cell, a diameter of 21 mm, and a height of 70 mm. In this embodiment, the energy storage apparatus 20 has an output voltage of 10*4 V/Cell=40 V, an output power of 10*4*30=1200 W, and a weight of 10*70 g/Cell=700 g. A power-to-weight ratio of the energy storage apparatus 20 is 1200 W/700 g=1.714 W/g. As shown in FIG. 4A, the 10 cells 200 are divided into two groups, each group includes 5 cells 200, and the two groups of cells 200 are arranged in upper and lower layers. Each cell 200 includes a horizontal central axis along a length direction and a central axis perpendicular to the horizontal central axis. A horizontal central axis of the first group of cells 200 is arranged on a first plane 23, and a horizontal central axis of the second group of cells 200 is arranged on a second plane 24, where the first plane 23 and the second plane 24 are arranged parallel to each other. A central axis of each cell 200 in the first group is aligned with a central axis of a corresponding cell 200 in the second group. For example, a central axis of the first cell 200 in the first group of cells 200 is aligned with a central axis of the first cell 200 in the second group, and a central axis of the second cell 200 in the first group of cells 200 is aligned with a central axis of the second cell 200 in the second group. According to a one-to-one correspondence, central axes of the cells 200 in first group respectively correspond to central axes of the corresponding cells 200 in the second group. Based on such arrangement, the energy storage apparatus 20 has a length of 21*5=105 mm, a width of 70 mm, a height of 21*2=42 mm, and a volume of 105*70*42=308.7 cm³. A power-to-volume ratio of the energy storage apparatus 20 is 1200 W/308.7 cm³=3.887 W/cm³.

The energy storage apparatus 20 according to the foregoing embodiment includes 10 cells 200. The 10 cells 200 are connected in series to each other and have an output voltage of 40 V, which does not exceed a safe voltage, and can meet the output power requirements. In addition, since the plurality of cells 200 are connected in series to each other, there is no mutual charging risk. Not only output power requirements are met, but also battery damage is avoided.

Table 1 is a table of comparison between two energy storage apparatuses when the electrical tool requires a rated power of 1200 W.

TABLE 1

| | | | | | | Power-to- | | Power-to- | Single pack |
|---|---|---|---|---|---|---|---|---|---|
| Power | Cell | Cell | Voltage | Current | Weight | weight ratio | Volume | volume ratio | duration |
| (W) | type | arrangement | (V) | (A) | (g) | (W/g) | (cm³) | (W/cm³) | (min) |
| 1200 | 18650 | Series | 60 | 20 | 675 | 1.778 | 315.9 | 3.799 | 6 |
| | | connection | | | | | | | |
| 1280 | 18650 | Parallel | 32 | 40 | 720 | 1.778 | 336.96 | 3.799 | 6 |
| | | connection | | | | | | | |
| 1200 | 21700 | Series | 40 | 30 | 700 | 1.714 | 308.7 | 3.887 | 8 |
| | | connection | | | | | | | |

For ease of description, hereinafter, an energy storage apparatus with 21700 cells is referred to as a first energy storage apparatus, and an energy storage apparatus with 18650 cells is referred to as a second energy storage apparatus. It can be seen from Table 1 that, basically the same output power (1200 W) is provided, and the first energy storage apparatus includes cells connected in series to each other, to avoid damage to the cells caused by a mutual charging current between cells connected in parallel, and in addition, has a single pack duration longer than that of the second energy storage apparatus, so that an electrical tool equipped with the first energy storage apparatus has a longer operation time. Moreover, a power-to-weight ratio of the first energy storage apparatus is smaller than a power-to-weight ratio of the second energy storage apparatus. In a case that the first energy storage apparatus ensures a high power, the weight of the energy storage apparatus does not increase, which is beneficial to a lightweight design of the electrical tool. In addition, a power-to-volume ratio of the first energy storage apparatus ranges from 3.8 W/cm³ to 4.0 W/cm³. In a case that it is ensured that the first energy storage apparatus outputs a high power, a volume of the first energy storage apparatus does not greatly increase, which is beneficial to a compact design of the electrical tool.

In a possible scenario, a rated power of the electrical tool 10 is 1400 W. The rated power means a rated input power. To meet the rated power, an output power of the energy storage apparatus needs to reach 1400 W. In the related art, an energy storage apparatus 20 including 18650 cells 200 is configured to provide electrical energy for a tool.

If the existing second energy storage apparatus is adopted, cells of the existing energy storage apparatus are 18650 cells. To reach a rated output power of 1400 W, the energy storage apparatus includes a battery units formed by 18 18650 cells connected in series to each other, and the energy storage apparatus includes one battery unit, that is, the energy storage apparatus includes 18 18650 cells connected in series to each other. Electrical energy of the energy storage apparatus is respectively connected to a positive electrode and a negative electrode of the electrical tool by the positive terminal and the negative terminal, to provide electrical energy for the electrical tool. The 18650 cell has an average discharge current of 20 A, a full charge voltage of 4.0 V/Cell, a weight of 45 g/Cell, a diameter of 18 mm, and a height of 65 mm. An output voltage of 18 18650 cells connected in series is 18*4 V/Cell=72 V. The energy storage apparatus has an output voltage of 72 V, an output power of 72 V*20 A=1440 W, and a weight of 18*45 g/Cell=810 g. A power-to-weight ratio of the energy storage apparatus is 1440 W/810 g=1.778 W/g. The 18 cells connected in series to each other in the energy storage apparatus are arranged in an upper layer, a middle layer, and a lower layer. Based on such arrangement, the energy storage apparatus has a length of 18*6=108 mm, a width of 65 mm, a height of 18*3=54 mm, and a volume of 108*65*54=379.08 cm³. A power-to-volume ratio of the energy storage apparatus is 1440 W/379.08 cm³=3.799 W/cm³.

In the foregoing solution, the energy storage apparatus 20 includes 18 18650 cells connected in series, and the output voltage of the energy storage apparatus reaches 60 V, which exceeds a safe voltage and poses a safety risk. In addition, after mating with a tool, the energy storage apparatus 20 has higher galvanic isolation requirements for the electrical tool and higher design requirements for the tool. To reduce the safety risk, design difficulty, and costs, in the related art, an energy storage apparatus is further provided. The energy storage apparatus includes 18 cells. The 18 cells form three battery units. Each battery unit includes 6 18650 cells connected in series to each other. The three battery units are connected in parallel to each other. According to the specifications of the 18650 cell, each group of cells has an output voltage of 6*4 V/Cell=24 V and an allowable average discharge current of 20 A. The three battery units connected in parallel still have an output voltage of 24 V and have an allowable average discharge current of 20 A*3=60 A. In this embodiment, the energy storage apparatus has an output voltage of 24 V and an output power of 24 V*60 A=1440 W, and a weight of the energy storage apparatus is 18*45 g/Cell=810 g. A power-to-weight ratio of the energy storage apparatus is 1440 W/810 g=1.778 W/g. The 18 cells in the energy storage apparatus are arranged in an upper layer, a middle layer, and a lower layer, and 6 cells are arranged in each layer. Based on such arrangement, the energy storage apparatus has a length of 18*6=108 mm, a width of 65 mm, a height of 18*3=54 mm, and a volume of 108*65*54=379.08 cm³. A power-to-volume ratio of the energy storage apparatus is 1440 W/379.08 cm³=3.799 W/cm³.

In the foregoing solution, the energy storage apparatus includes three battery units formed by 18 18650 cells. The three battery units are connected in parallel to each other. The energy storage apparatus formed by the battery units connected in parallel has n output voltage of 32 V, which is less than 60 V and meets requirements for the safety of operators, and there is no need to arrange galvanic isolation for the electrical tool. However, because the three battery units are connected in parallel, when the three battery units have different voltages, there is a risk that a battery unit with a higher voltage charges a battery unit with a lower voltage, which is referred to as a mutual charging risk for short. In a process of mutual charging, the greater the voltage difference, the higher the charging current. A high current causes serious damage to both a charged battery unit and a discharged battery unit, and even causes danger.

To resolve the operator safety problem, the damage to the battery pack, and the costs problem that the energy storage apparatus including 18650 cells in the related art faces when the energy storage apparatus needs to be output a power of 1400 W, the present utility model provides an energy storage apparatus, including a battery unit, where the battery unit includes a plurality of 21700 cells, and the plurality of cells are connected in series. In a third embodiment of the present utility model, the battery unit includes 12 21700 cells, and the energy storage apparatus includes one battery unit, that is, the energy storage apparatus includes 12 21700 battery cells connected in series to each other. The battery unit further includes a circuit board, an electrode plate arranged on the circuit board and configured to electrically connect to the cells, and a connection plate configured to connect two adjacent cells in series. The 21700 cell has an average discharge current of 30 A, a full charge voltage of 4.0 V/Cell, a weight of 70 g/Cell, a diameter of 21 mm, and a height of 70 mm. In this embodiment, the energy storage apparatus has an output voltage of 12*4 V/Cell=48 V, an output power of 12*4*30=1440 W, and a weight of 12*70 g/Cell=840 g. A power-to-weight ratio of the energy storage apparatus is 1440 W/840 g=1.714 W/g. The 12 cells in the energy storage apparatus are divided into three groups, each group includes 4 cells, and the three groups of cells are arranged in an upper layer, a middle layer, and a lower layer. Each cell includes a horizontal central axis along a length direction and a central axis perpendicular to the horizontal central axis. A horizontal central axis of the first group of cells is arranged on a first plane, a horizontal central axis of the second group of cells is arranged on a second plane, and a horizontal central axis of the third group of cells is arranged on a third plane, where the first plane, the second plane, and the third plane are arranged parallel to each other, and three planes are all arranged parallel to a base plane. A central axis of each cell in the first group are aligned with a central axis of a corresponding cell in the second and third groups. A central axis of the first cell in the first group of cells is aligned with a central axis of the first cell in the second group and a central axis of the first cell in the third group. A central axis of the second cell in the first group of cells is aligned with a central axis of the second cell in the second group and a central axis of the second cell in the third group. According to a one-to-one correspondence, central axes of cells in the first group respectively correspond to the central axes of corresponding cells in the second group and corresponding cells in the third group. Based on such arrangement, the energy storage apparatus is cylindrical, the central axes of the upper and lower battery cells are aligned with each other, and the energy storage apparatus has a length of 21*4=84 mm, a width of 70 mm, a height of 21*3=63 mm, and a volume of 84*70*63=370.44 cm³. A power-to-volume ratio of the energy storage apparatus is 1440 W/370.44 cm³=3.887 W/cm³.

The energy storage apparatus 20 according to Embodiment includes 12 cells, the 12 cells are connected in series to each other and have an output voltage is 48 V, which does not exceed a safe voltage, and can meet the output power requirements. In addition, since the plurality of cells are connected in series to each other, there is no mutual charging risk. Not only output power requirements are met, but also battery damage is avoided.

Table 2 is a table of comparison between two energy storage apparatuses when the electrical tool requires a rated power of 1400 W.

TABLE 2

| | | | | | | Power-to- | | Power-to- | Single pack |
|---|---|---|---|---|---|---|---|---|---|
| Power | Cell | Cell | Voltage | Current | Weight | weight ratio | Volume | volume ratio | duration |
| (W) | type | arrangement | (V) | (A) | (g) | (W/g) | (cm³) | (W/cm³) | (min) |
| 1440 | 18650 | Series | 72 | 20 | 810 | 1.778 | 379.08 | 3.799 | 6 |
| | | connection | | | | | | | |
| 1440 | 18650 | Parallel | 24 | 60 | 810 | 1.778 | 379.08 | 3.799 | 6 |
| | | connection | | | | | | | |
| 1440 | 21700 | Series | 48 | 30 | 700 | 1.714 | 370.44 | 3.887 | 8 |
| | | connection | | | | | | | |

It can be seen from Table 2 that, basically a same output power (1440 W) is provided, and the first energy storage apparatus includes the cells connected in series to each other, to avoid damage to the cells caused by a mutual charging current between the cells connected in parallel, and in addition, has a single pack duration longer than that of the second energy storage apparatus. Moreover, a power-to-weight ratio of the first energy storage apparatus is smaller than a power-to-weight ratio of the second energy storage apparatus. In a case that the first energy storage apparatus ensures a high power, the weight of the energy storage apparatus does not increase, which is beneficial to a lightweight design of the electrical tool. In addition, a power-to-volume ratio of the first energy storage apparatus ranges from 3.8 W/cm³ to 4.0 W/cm³. In a case that it is ensured that the first energy storage apparatus outputs a high power, a volume of the first energy storage apparatus does not greatly increase, which is beneficial to a compact design of the electrical tool.

In a possible scenario, a rated power of the electrical tool 10 is 1600 W. The rated power means a rated input power. To meet the rated power, an output power of the energy storage apparatus needs to reach 1600 W. In the related art, an energy storage apparatus 20 including 18650 cells 200 is configured to provide electrical energy for a tool.

If the existing energy storage apparatus is adopted, cells of the existing energy storage apparatus are 18650 cells. To reach a rated output power of 1600 W, the energy storage apparatus includes 20 18650 cells, the 20 cells are connected in series to each other to form one battery unit, and the energy storage apparatus includes one battery unit, that is, the energy storage apparatus includes 20 18650 cells connected in series to each other. The 18650 cell has an average discharge current of 20 A, a full charge voltage of 4.0 V/Cell, a weight of 45 g/Cell, a diameter of 18 mm, and a height of 65 mm. An output voltage of 20 18650 cells connected in series is 20*4 V/Cell=80 V. The energy storage apparatus has an output voltage of 80 V, an output power of 80 V*20 A=1600 W, and a weight of 20*45 g/Cell=900 g. A power-to-weight ratio of the energy storage apparatus is 1600 W/900 g=1.778 W/g. The 20 cells in the energy storage apparatus are arranged in an upper layer, a middle layer, and a lower layer. Based on such arrangement, the energy storage apparatus has a length of 18*7=126 mm, a width of the energy storage apparatus is 65 mm, a height of 18*3=54 mm, and a volume of 126*65*54=442.26 cm³. A power-to-volume ratio of the energy storage apparatus is 1600 W/442.26 cm³=3.618 W/cm³.

In the foregoing solution, the energy storage apparatus 20 includes 18 18650 cells connected in series, and the output voltage of the energy storage apparatus reaches 60 V, which exceeds a safe voltage and poses a safety risk. In addition, after mating with a tool, the energy storage apparatus 20 has higher galvanic isolation requirements for the electrical tool and higher design requirements for the tool. To reduce the safety risk, design difficulty, and costs, in the related art, an energy storage apparatus is further provided. The energy storage apparatus includes 21 cells. The 21 cells form three battery units. Each battery unit includes 7 18650 cells connected in series to each other. The three battery units are connected in parallel to each other. According to specifications of the 18650 cells, each battery unit has an output voltage of 7*4 V/Cell=28 V and an allowable average discharge current of 20 A. The battery units connected in parallel still have an output voltage of 28 V and have an allowable average discharge current of 20 A*3=60 A. In this embodiment, the energy storage apparatus has an output voltage of 28 V and an output power of 28 V*60 A=1680 W. A weight of the energy storage apparatus is 21*45 g/Cell=945 g. A power-to-weight ratio of the energy storage apparatus is 1680 W/945 g=1.778 W/g. The 21 cells in the energy storage apparatus are arranged in an upper layer, a middle layer, and a lower layer, and one battery unit, that is, 7 cells, is arranged in each layer. Based on such arrangement, the energy storage apparatus has a length of 18*7=126 mm, a width of the energy storage apparatus is 65 mm, a height of 18*3=54 mm, and a volume of 126*65*54=442.26 cm³. A power-to-volume ratio of the energy storage apparatus is 1680 W/442.26 cm³=3.799 W/cm³.

In the foregoing solution, the energy storage apparatus includes three battery units formed by 21 18650 cells. The three battery units are connected in parallel to each other. The energy storage apparatus formed by the battery units connected in parallel has n output voltage of 28 V, which is less than 60 V and meets requirements for the safety of operators, and there is no need to arrange galvanic isolation for the electrical tool. However, because the two battery units are connected in parallel, when the two battery units have different voltages, there is a risk that a battery unit with a higher voltage charges a battery unit with a lower voltage, which is referred to as a mutual charging risk for short. In a process of mutual charging, the greater the voltage difference, the higher the charging current. A high current causes serious damage to both a charged battery unit and a discharged battery unit, and even causes danger.

To resolve the operator safety problem, the damage to the battery pack, and the costs problem that the energy storage apparatus including 18650 cells in the related art faces when the energy storage apparatus needs to be output a power of 1600 W, the present utility model provides an energy storage apparatus, including a battery unit, where the battery unit includes a plurality of 21700 cells, and the plurality of cells are connected in series. In Embodiment 3 of the present utility model, the energy storage apparatus includes 14 21700 cells connected in series to each other, the 14 cells form one battery unit, and the energy storage apparatus includes one battery unit, that is, an energy storage unit includes 14 21700 cells connected in series to each other. The 21700 cell has an average discharge current of 30 A, a full charge voltage of 4.0 V/Cell, a weight of 70 g/Cell, a diameter of 21 mm, and a height of 70 mm. In this embodiment, the energy storage apparatus has an output voltage of 14*4 V/Cell=56 V, an output power of 14*4*30=1680 W, and a weight of 14*70 g/Cell=980 g. A power-to-weight ratio of the energy storage apparatus is 1680 W/980 g=1.714 W/g. The 14 cells in the energy storage apparatus are divided into two groups, each group includes 7 cells, and the two groups of cells are arranged in upper and lower layers. Each cell includes a horizontal central axis along a length direction and a central axis perpendicular to the horizontal central axis. A horizontal central axis of the first group of cells is arranged on a first plane, and a horizontal central axis of the second group of cells is arranged on a second plane, where the first plane and the second plane are arranged parallel to each other, and both planes are arranged parallel to a base plane. A central axis of each cell in the first group are aligned with a central axis of a corresponding cell in the second group. A central axis of the first cell in the first group of cells is aligned with a central axis of the first cell in the second group, and a central axis of the second cell in the first group of cells is aligned with a central axis of the second cell in the second group. According to a one-to-one correspondence, central axes of cells in the first group respectively correspond to central axes of the corresponding cells in the second group. Based on such arrangement, the energy storage apparatus has a length of 21*7=147 mm, a width of the energy storage apparatus is 70 mm, a height of 21*2=42 mm, and a volume of 147*70*42=432.18 cm³. A power-to-volume ratio of the energy storage apparatus is 1680 W/432.18 cm³=3.887 W/cm³.

The energy storage apparatus according to Embodiment includes 14 cells. The 14 cells are connected in series to each other and have an output voltage of 56 V, which does not exceed a safe voltage, and can meet the output power requirements. In addition, since the plurality of cells are connected in series to each other, there is no mutual charging risk. Not only output power requirements are met, but also battery damage is avoided.

Table 3 is a table of comparison between two energy storage apparatuses when the electrical tool requires a rated power of 1600 W.

TABLE 3

| | | | | | | Power-to- | | Power-to- | Single pack |
|---|---|---|---|---|---|---|---|---|---|
| Power | Cell | Cell | Voltage | Current | Weight | weight ratio | Volume | volume ratio | duration |
| (W) | type | arrangement | (V) | (A) | (g) | (W/g) | (cm³) | (W/cm³) | (min) |
| 1600 | 18650 | Series | 80 | 20 | 900 | 1.778 | 442.26 | 3.618 | 6 |
| | | connection | | | | | | | |
| 1680 | 18650 | Parallel | 28 | 60 | 945 | 1.778 | 442.26 | 3.799 | 6 |
| | | connection | | | | | | | |
| 1680 | 21700 | Series | 56 | 30 | 980 | 1.714 | 432.18 | 3.887 | 8 |
| | | connection | | | | | | | |

It can be seen from Table 3 that, basically a same output power (1600 W) is provided, and the first energy storage apparatus includes the cells connected in series to each other, to avoid damage to the cells caused by a mutual charging current between the cells connected in parallel, and in addition, has a single pack duration longer than that of the second energy storage apparatus. Moreover, a power-to-weight ratio of the first energy storage apparatus is smaller than a power-to-weight ratio of the second energy storage apparatus. In a case that the first energy storage apparatus ensures a high power, the weight of the energy storage apparatus does not increase, which is beneficial to a lightweight design of the electrical tool. A power-to-volume ratio of the first energy storage apparatus ranges from 3.8 W/cm³ to 4.0 W/cm³. In a case that it is ensured that the first energy storage apparatus outputs a high power, a volume of the first energy storage apparatus does not greatly increase, which is beneficial to a compact design of the electrical tool.

In a possible scenario, a rated power of the electrical tool 10 is 1800 W. The rated power means a rated input power. To meet the rated power, an output power of the energy storage apparatus needs to reach 1800 W. In the related art, an energy storage apparatus 20 including 18650 cells 200 is configured to provide electrical energy for a tool.

If the existing energy storage apparatus is adopted, cells of the existing energy storage apparatus are 18650 cells. To reach a rated output power of 1800 W, the energy storage apparatus includes 23 18650 cells, the 23 cells are connected in series to each other to form one battery unit, and the energy storage apparatus includes one battery unit, that is, the energy storage apparatus includes 23 18650 cells connected in series to each other. The 18650 cell has an average discharge current of 20 A, a full charge voltage of 4.0 V/Cell, a weight of 45 g/Cell, a diameter of 18 mm, and a height of 65 mm. An output voltage of 23 18650 cells connected in series is 23*4 V/Cell=92 V. The energy storage apparatus has an output voltage of 92 V, an output power of 92 V*20 A=1840 W, and a weight of 23*45 g/Cell=1035 g. A power-to-weight ratio of the energy storage apparatus is 1840 W/1035 g=1.778 W/g. The 23 cells in the energy storage apparatus are arranged in an upper layer, a middle layer, and a lower layer. Based on such arrangement, the energy storage apparatus has a length of 18*8=144 mm, a width of 65 mm, a height of 18*3=54 mm, and a volume of 144*65*54=505.44 cm³. A power-to-volume ratio of the energy storage apparatus is 1840 W/505.44 cm³=3.64 W/cm³.

In the foregoing solution, the energy storage apparatus 20 includes 23 18650 cells connected in series, and the output voltage of the energy storage apparatus reaches 92 V, which exceeds a safe voltage and poses a safety risk. In addition, after mating with a tool, the energy storage apparatus 20 has higher galvanic isolation requirements for the electrical tool and higher design requirements for the tool. To reduce the safety risk, design difficulty, and costs, in the related art, an energy storage apparatus is further provided. The energy storage apparatus includes 24 cells. The 24 cells form three battery units. Each battery unit includes 8 18650 cells connected in series to each other. The three battery units are connected in parallel to each other. According to the specifications of the 18650 cell, each battery unit has an output voltage of 8*4 V/Cell=32 V and an allowable average discharge current of 20 A. The battery units connected in parallel still have an output voltage of 32 V and have an allowable average discharge current of 20 A*3=60 A. In this embodiment, the energy storage apparatus has an output voltage of 32 V and an output power of 32 V*60 A=1920 W. A weight of the energy storage apparatus is 24*45 g/Cell=1080 g. A power-to-weight ratio of the energy storage apparatus is 1920 W/1080 g=1.778 W/g. The 24 cells in the energy storage apparatus are arranged in an upper layer, a middle layer, and a lower layer, 8 cells are arranged in each battery plane, and three planes all are arranged parallel to a base plane. Based on such arrangement, the energy storage apparatus has a length of 18*8=144 mm, a width of 65 mm, a height of 18*3=54 mm, and a volume of 144*65*54=505.44 cm³. A power-to-volume ratio of the energy storage apparatus is 1920 W/505.44 cm³=3.799 W/cm³.

In the foregoing solution, the energy storage apparatus includes three battery units formed by 24 18650 cells. The three battery units are connected in parallel to each other. The energy storage apparatus formed by the battery units connected in parallel has n output voltage of 32 V, which is less than 60 V and meets requirements for the safety of operators, and there is no need to arrange galvanic isolation for the electrical tool. However, because the two battery units are connected in parallel, when the two battery units have different voltages, there is a risk that a battery unit with a higher voltage charges a battery unit with a lower voltage, which is referred to as a mutual charging risk for short. In a process of mutual charging, the greater the voltage difference, the higher the charging current. A high current causes serious damage to both a charged battery unit and a discharged battery unit, and even causes danger.

To resolve the operator safety problem, the damage to the battery pack, and the costs problem that the energy storage apparatus including 18650 cells in the related art faces when the energy storage apparatus needs to be output a power of 1800 W, the present utility model provides an energy storage apparatus, including a battery unit, where the battery unit includes a plurality of 21700 cells, and the plurality of cells are connected in series. In Embodiment 4 of the present utility model, the energy storage apparatus includes 15 21700 cells connected in series to each other, the 15 cells form one battery unit, and the energy storage apparatus includes one battery unit, that is, an energy storage unit includes 15 21700 cells connected in series to each other. The 21700 cell has an average discharge current of 30 A, a full charge voltage of 4.0 V/Cell, a weight of 70 g/Cell, a diameter of 21 mm, and a height of 70 mm. In this embodiment, the energy storage apparatus has an output voltage of 15*4 V/Cell=60 V, an output power of 15*4*30=1800 W, and a weight of 15*70 g/Cell=1050 g. A power-to-weight ratio of the energy storage apparatus is 1800 W/1050 g=1.714 W/g. The 15 cells in the energy storage apparatus are divided into three groups, each group includes 5 cells, and the three groups of cells are arranged in an upper layer, a middle layer, and a lower layer. Each cell includes a horizontal central axis along a length direction and a central axis perpendicular to the horizontal central axis. A horizontal central axis of the first group of cells is arranged on a first plane, a horizontal central axis of the second group of cells is arranged on a second plane, and a horizontal central axis of the third group of cells is arranged on a third plane, where the first plane, the second plane, and the third plane are arranged parallel to each other, and three planes are all arranged parallel to a base plane. A central axis of each cell in the first group is aligned with a central axis of a corresponding cell in the second group and a central axis of a corresponding cell in the third group. For specific arrangement, reference may be made to FIG. 4, and details are not described herein again. Based on such arrangement, the energy storage apparatus has a length of 21*8=168 mm, a width of 70 mm, a height of 21*2=42 mm, and a volume of 168*70*42=493.92 cm³. A power-to-volume ratio of the energy storage apparatus is 1800 W/493.92 cm³=3.644 W/cm³.

The energy storage apparatus according to Embodiment 4 includes 15 cells. The 15 cells are connected in series to each other and have an output voltage is 60 V, which does not exceed a safe voltage, and can meet the output power requirements. In addition, since the plurality of cells are connected in series to each other, there is no mutual charging risk. Not only output power requirements are met, but also battery damage is avoided.

Table 4 is a table of comparison between two energy storage apparatuses when the electrical tool requires a rated power of 1800 W.

TABLE 4

| | | | | | | Power-to- | | Power-to- | Single pack |
|---|---|---|---|---|---|---|---|---|---|
| Power | Cell | Cell | Voltage | Current | Weight | weight ratio | Volume | volume ratio | duration |
| (W) | type | arrangement | (V) | (A) | (g) | (W/g) | (cm³) | (W/cm³) | (min) |
| 1840 | 18650 | Series | 92 | 20 | 1035 | 1.778 | 505.44 | 3.64 | 6 |
| | | connection | | | | | | | |
| 1920 | 18650 | Parallel | 32 | 60 | 1080 | 1.778 | 505.44 | 3.799 | 6 |
| | | connection | | | | | | | |
| 1800 | 21700 | Series | 60 | 30 | 1050 | 1.714 | 493.92 | 3.644 | 8 |
| | | connection | | | | | | | |

It can be seen from Table 4 that, basically a same output power (1800 W) is provided, and the first energy storage apparatus includes the cells connected in series to each other, to avoid damage to the cells caused by a mutual charging current between the cells connected in parallel, and in addition, has a single pack duration longer than that of the second energy storage apparatus. Moreover, a power-to-weight ratio of the first energy storage apparatus is smaller than a power-to-weight ratio of the second energy storage apparatus. In a case that the first energy storage apparatus ensures a high power, the weight of the energy storage apparatus does not increase, which is beneficial to a lightweight design of the electrical tool. In addition, a power-to-volume ratio of the first energy storage apparatus ranges from 3.8 W/cm³ to 4.0 W/cm³. In a case that it is ensured that the first energy storage apparatus outputs a high power, a volume of the first energy storage apparatus does not greatly increase, which is beneficial to a compact design of the electrical tool.

According to the foregoing embodiments, the energy storage apparatus of the present utility model includes a battery unit, the battery unit includes a plurality of 21700 cells, and the plurality of cells are connected in series. Compared with the existing energy storage apparatus including 18650 cells, the energy storage apparatus according to the present utility model has the plurality of cells connected in series, which not only enables the electrical tool to meet the requirements for a rated input power, but also avoids a voltage of the electrical tool from exceeding a safe voltage and causing danger or a mutual charging risk due to a voltage difference between cells connected in parallel.

The electrical tool of the present utility model may be an electric hammer, an electric drill, an angle grinder, an electric wrench, an electric circular saw, a lawn trimmer, a pruning machine, a lawn mower, a hair dryer, a chainsaw, a high-pressure cleaner, or another electrical tool.

The present utility model is not limited to the structures of the specific embodiments described herein, and structures based on the concepts of the present utility model shall fall within the protection scope of the present utility model.

1. An energy storage apparatus, comprising:
a shell,
a first mating port configured to detachably mate with a second mating port on an electrical tool,
a positive terminal and a negative terminal set in the first mating port, and
a battery unit,
wherein the battery unit is accommodated in the shell and comprises a plurality of cells,
wherein the plurality of cells are connected in series, and
wherein an allowable output power of the energy storage apparatus is higher than 1200 W and an output voltage of the plurality of cells connected in series is not higher than 60V.

2. The energy storage apparatus according to claim 1, wherein the output voltage of the plurality of cells connected in series ranges from 40 V to 60 V,
wherein an output power of the energy storage apparatus ranges from 1200 W to 1800 W, and
wherein a power-to-volume ratio of the energy storage apparatus ranges from 3.8 W/cm³ to 4.0 W/cm³.

3. The energy storage apparatus according to claim 2, wherein the battery unit comprises at least 10 cells,
wherein the output power of the energy storage apparatus ranges from 1200 W to 1400 W, and
wherein a volume of the energy storage apparatus is greater than 300 cm³.

4. The energy storage apparatus according to claim 3, wherein a number of the cells is 10,
wherein allowable discharge currents of the cells are not lower than 30 A,
wherein the cells are arranged in an upper layer and a lower layer,
wherein 5 cells arranged side by side are arranged in each of the upper layer and the lower layer, and
wherein a central axis of the cells in the upper layer is aligned with a central axis of a corresponding cells in the lower layer.

5. The energy storage apparatus according to claim 2, wherein the battery unit comprises at least 12 cells,
wherein the output power of the energy storage apparatus ranges from 1400 W to 1600 W, and
wherein the volume of the energy storage apparatus is greater than 370 cm³.

6. The energy storage apparatus according to claim 5, wherein a number of the cells is 12,
wherein allowable discharge currents of the cells are not lower than 30 A,
wherein the cells are arranged in an upper layer, a middle layer, and a lower layer,
wherein 4 cells arranged side by side are arranged in each of the upper layer, the middle layer, and the lower layer, and
wherein central axis of corresponding cells in the upper layer, the middle layer, and the lower layer are aligned with each other.

7. The energy storage apparatus according to claim 2, wherein the battery unit comprises at least 14 cells,
wherein the output power of the energy storage apparatus ranges from 1600 W to 1800 W, and
wherein the volume of the energy storage apparatus is greater than 430 cm³.

8. The energy storage apparatus according to claim 7, wherein a number of the cells is 14,
wherein allowable discharge currents of the cells are not lower than 30 A,
wherein the cells are arranged in an upper layer and a lower layer,
wherein 7 cells arranged side by side are arranged in each of the upper layer and the lower layer, and
wherein a central axis of a cell in the upper layer is aligned with a central axis of a corresponding cell in the lower layer.

9. An electrical tool comprising an electrical tool body and an energy storage apparatus configured to power the electrical tool body, wherein the electrical tool body comprises:
a motor configured to obtain electrical energy from the energy storage apparatus to output rotational motion; and
a second mating port configured to mate with the energy storage apparatus to obtain the electrical energy;
wherein the energy storage apparatus is the energy storage apparatus according to claim 1.

10. The electrical tool according to claim 9, wherein the electrical tool is an outdoor electrical tool.
